(19) United States
(12) Patent Application Publication
(10) Pub. No.: US 2007/0035245 A1
(43) Pub. Date: Feb. 15, 2007

(54) Flat-type fluorescent lamp, method of manufacturing the same, backlight assembly having the same and display device having the same

(75) Inventors: Hyun-Chul Bae, Suwon-si (KR); Hea-Chun Lee, Suwon-si (KR); Jin-Seob Byun, Seoul (KR); Jae-Sang Lee, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/454,465

(22) Filed: Jun. 16, 2006

(30) Foreign Application Priority Data
Aug. 9, 2005 (KR) 2005-72547

(51) Int. Cl. H01J 61/00; H01J 11/00

(52) U.S. Cl. 313/581; 313/234; 313/607

(57) ABSTRACT

A flat-type fluorescent lamp includes a first substrate, a second substrate and an adhesive member. The second substrate corresponds to the first substrate to form a plurality of discharge spaces. The adhesive member is interposed between the first and second substrates to combine the first substrate with the second substrate. The adhesive member includes a protrusion protruding in a longitudinal direction of the discharge spaces. Therefore, luminance uniformity and image display quality are improved.

### CROSS-REFERENCE TO RELATED APPLICATIONS

The present application claims priority from Korean Patent Application No. 2005-72547, filed on Aug. 9, 2005, the disclosure of which is hereby incorporated herein by reference in its entirety.

### BACKGROUND OF THE INVENTION

1. Technical Field

The present disclosure relates to a flat-type fluorescent lamp, a method of manufacturing the flat-type fluorescent lamp, a backlight assembly having the flat-type fluorescent lamp, and a display device having the flat-type fluorescent lamp. More particularly, the present disclosure relates to a flat-type fluorescent lamp capable of improving luminance uniformity, a method of manufacturing the flat-type fluorescent lamp, a backlight assembly having the flat-type fluorescent lamp, and a display device having the flat-type fluorescent lamp that provides an improved image display quality.

2. Discussion of the Related Art

A liquid crystal display (LCD) device, in general, displays an image using liquid crystals. The LCD device is a flat panel display device, and the LCD device has various characteristics such as a reduced thickness, a low driving voltage, a low power consumption, etc., so that it has been widely used in various fields.

The LCD device is a nonemissive-type display device and this requires a backlight assembly that supplies an LCD panel with light.

Recently, since LCD devices have become bigger, a flat-type fluorescent lamp, which is used for a large-screen LCD device, is being developed in an attempt to decrease the manufacturing cost and to simplify the steps in the manufacturing process. The flat-type fluorescent lamp includes a lamp body and a driving electrode. The lamp body is divided into a plurality of discharge spaces that generate the light of the lamp. A discharge voltage is applied to the lamp body through the driving electrode. When the discharge voltage is applied to the driving electrode, a plasma discharge is generated in the discharge spaces. Excitons are generated by the plasma discharge that in turn generate an ultraviolet light. A fluorescent layer on the lamp body changes the ultraviolet light into visible light.

In the initial stage of producing light, a temperature of the flat-type fluorescent lamp is low, so that a luminance of the flat-type fluorescent lamp is also low. In order to increase the luminance in the initial stage, a high voltage is applied to the flat-type fluorescent lamp. However, when the high voltage is applied to the flat-type fluorescent lamp, a channeling formed between adjacent discharge spaces deteriorates a uniformity of the luminance of the flat-type fluorescent lamp.

### SUMMARY OF THE INVENTION

Embodiments of the present invention provide a flat-type fluorescent lamp capable of improving luminance uniformity, a method of manufacturing the above-mentioned flat-type fluorescent lamp having improved luminance uniformity, a backlight assembly having a flat-type fluorescent lamp with improved luminance uniformity, and a display device having a flat-type fluorescent lamp with improved luminance uniformity, thereby to improve image display quality.

A flat-type fluorescent lamp in accordance with an embodiment of the present invention includes a first substrate, a second substrate and an adhesive member. The second substrate corresponds to the first substrate to form a plurality of discharge spaces. The adhesive member is interposed between the first and second substrates to combine the first substrate with the second substrate. The adhesive member has a predetermined fixed thickness and includes at least one protrusion extending into the body of the lamp.

A flat-type fluorescent lamp in accordance with an embodiment of the present invention includes a first substrate and a second substrate. The second substrate includes a plurality of discharge channeling portions, a plurality of space dividing portions and a sealing portion. The discharge channeling portions are spaced apart from the first substrate. The space dividing portions make contact with the first substrate between the discharge channeling portions. A portion of each of the space dividing portions is attached to the first substrate. A remaining portion of each of the space dividing portions makes contact with the first substrate. The sealing portion is on a peripheral portion of the second substrate and is attached to the first substrate.

A backlight assembly in accordance with an embodiment of the present invention includes a flat-type fluorescent lamp, a receiving container and an insulating member. The flat-type fluorescent lamp includes a lamp body, a first external electrode and a second external electrode. The lamp body generates light, and includes an adhesive member having at least one protrusion. The first external electrode is on an upper surface of the lamp body. The second external electrode is on a lower surface of the lamp body. The receiving container includes a bottom plate and a sidewall to receive the flat-type fluorescent lamp. The insulating member is interposed between the flat-type fluorescent lamp and the receiving container, so that the flat-type fluorescent lamp is spaced apart from the receiving container.

A display device in accordance with an embodiment of the present invention includes a backlight assembly and a display unit. The backlight assembly generates light and includes a flat-type fluorescent lamp, a receiving container and an insulating member. The flat-type fluorescent lamp includes a lamp body, an adhesive member and an external electrode. The lamp body includes a plurality of discharge spaces. The adhesive member is along a side of the lamp body and includes a protrusion protruding from a side of the lamp body toward a central portion of the lamp body. The external electrode is on the lamp body. The receiving container includes a bottom plate and a sidewall that receives the flat-type fluorescent lamp. The insulating member is interposed between the flat-type fluorescent lamp and the receiving container, so that the flat-type fluorescent lamp is spaced apart from the receiving container. The display unit displays an image using the light generated from the backlight assembly.

A method of manufacturing a flat-type fluorescent lamp in accordance with an embodiment of the present invention is provided in which a first substrate is formed. A second substrate including a plurality of discharge channeling portions, a plurality of space dividing portions between the discharge channeling portions, and a sealing portion of a peripheral portion of the second substrate are formed. The sealing portion and a portion of each of the space dividing portions are attached to the first substrate.

According to the present invention, the channeling is decreased in the initial stage of producing light in order to increase a luminance uniformity of the backlight assembly, thereby improving an image display quality of the display device.

### BRIEF DESCRIPTION OF THE DRAWINGS

The above and other advantages of the present invention will become more apparent by describing in detail exemplary embodiments thereof with reference to the accompanying drawings, in which:

FIG. 1 is an exploded perspective view showing a flat-type fluorescent lamp in accordance with an embodiment of the present invention;

FIG. 2 is a cross-sectional view taken along a line I-I′ shown in FIG. 1;

FIG. 3 is a plan view showing the flat-type fluorescent lamp shown in FIG. 1;

FIG. 4 is a plan view showing a flat-type fluorescent lamp in accordance with an embodiment of the present invention;

FIG. 5 is an exploded perspective view showing a backlight assembly in accordance with an embodiment of the present invention;

FIG. 6 is a cross-sectional view taken along a line 11-II′ shown in FIG. 5; and

FIG. 7 is an exploded perspective view showing a display device in accordance with an embodiment of the present invention.

### DESCRIPTION OF THE EXEMPLARY EMBODIMENTS

The invention is described more fully hereinafter with reference to the accompanying drawings. This invention may, however, be embodied in many different forms and should not be construed as limited to the embodiments set forth herein.

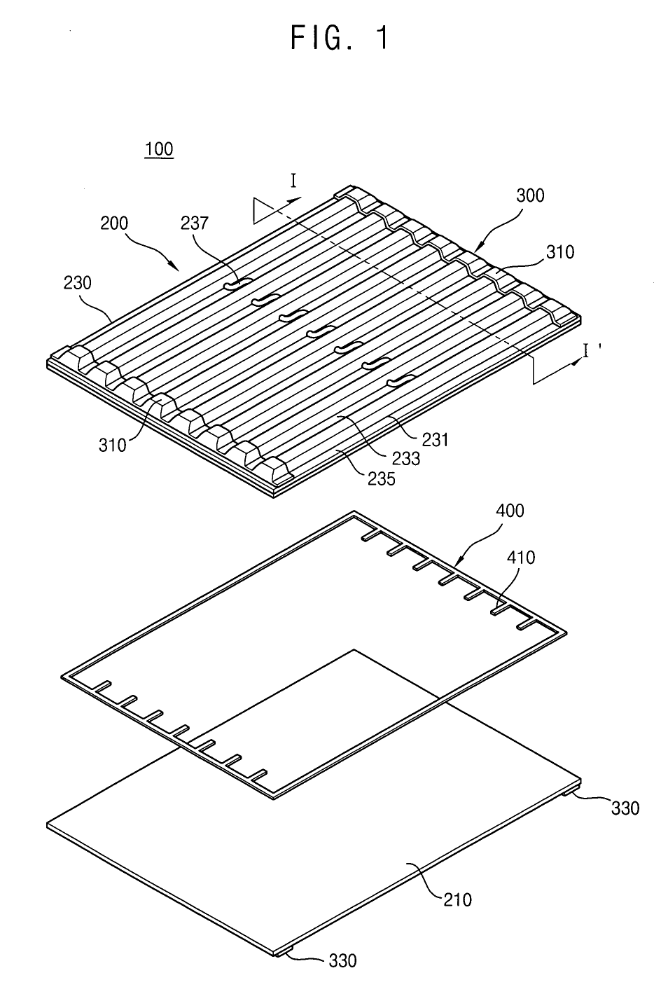

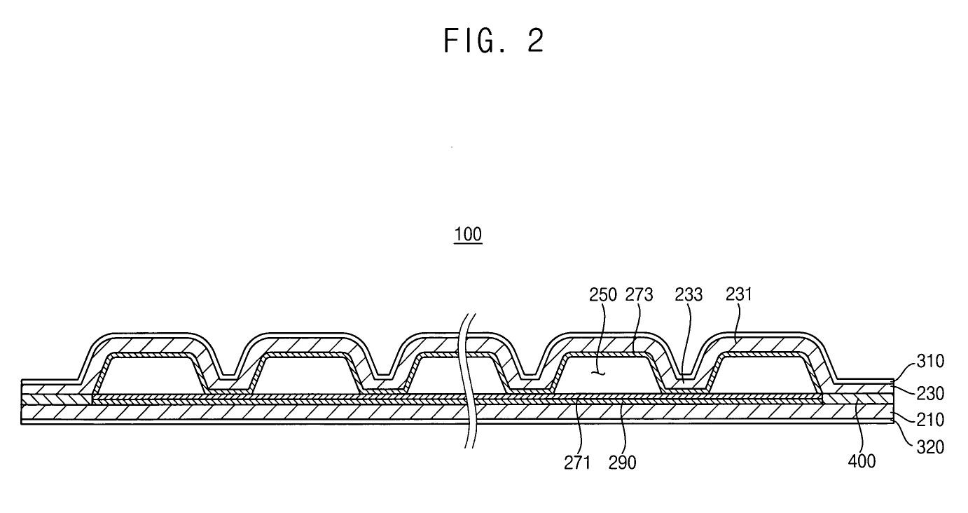

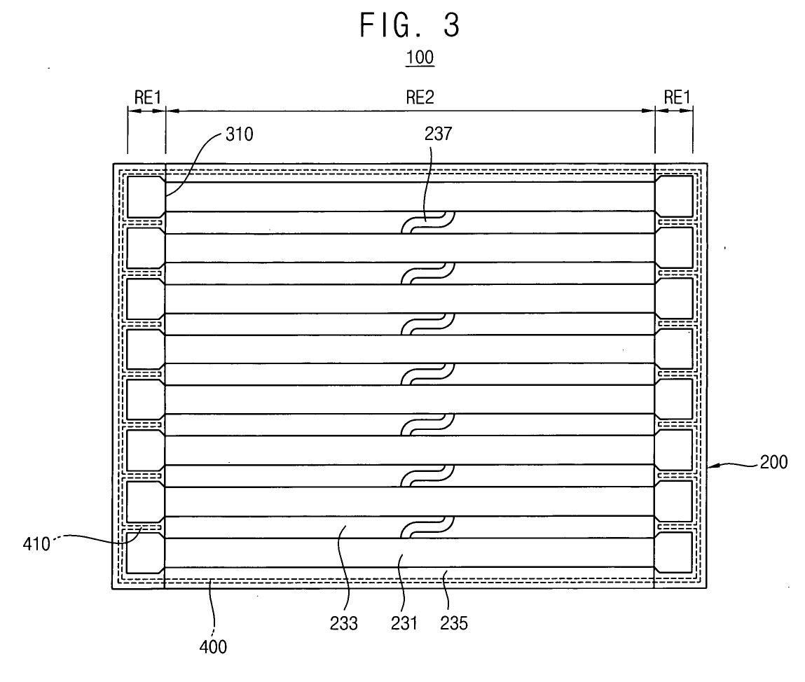

FIG. 1 is an exploded perspective view showing a flat-type fluorescent lamp in accordance with an embodiment of the present invention. FIG. 2 is a cross-sectional view taken along a line I-I′ shown in FIG. 1. FIG. 3 is a plan view showing the flat-type fluorescent lamp shown in FIG. 1.

Referring to FIGS. 1 to 3, the flat-type fluorescent lamp 100 includes a lamp body 200, at least one external electrode assembly 300 and an adhesive member 400. A light is generated from the lamp body 200. Examples of the light generated from the lamp body 200 are a visible light, a bluish light, etc. The external electrode assembly 300 may be on at least one of an upper surface and a lower surface of the lamp body 200.

The lamp body 200 includes a first substrate 210 and a second substrate 230. The second substrate 230 is combined with the first substrate 210 to form a plurality of discharge spaces 250.

The first substrate 210 has a substantially quadrangular plate shape, and, for example, the first substrate 210 may be made of glass. The first substrate 210 may include an ultraviolet light blocking material to block ultraviolet light generated from the discharge spaces 250.

The second substrate 230 may be formed through a molding process. The second substrate 230 is formed of a transparent material to transmit a visible light generated from the discharge spaces 250 and, for example, the second substrate 230 may also be made of glass. The second substrate 230 may also include the ultraviolet light blocking material to block the ultraviolet light generated from the discharge spaces 250.

The second substrate 230 may be formed through various molding processes. For example, a glass plate is heated and pressed to form the second substrate 230. Alternatively, the second substrate 230 may be formed through a blow molding process. In the blow molding process, the glass plate is heated and compressed by air to form the second substrate 230.

The second substrate 230 includes a discharge channeling portion 231, a space dividing portion 233, a sealing portion 235 and a connecting passage 237. Alternatively, the second substrate 230 may further include a plurality of discharge channeling portions, a plurality of space dividing portions, a plurality of sealing portions and a plurality of connecting passages.

The discharge channeling portions 231 are spaced apart from the first substrate 210 to form the discharge spaces 250. A discharge is formed in the discharge spaces 250 that are formed by the discharge channeling portions 231. The space dividing portions 233 make contact with the first substrate 210 between adjacent discharge channeling portions 231 to define the discharge spaces 250. A cross-section of the second substrate 230 includes a plurality of trapezoidal shapes that are connected to each other. The trapezoidal shapes may have rounded corners and are arranged substantially in parallel. Alternatively, the cross-section of the second substrate 230 may have a semicircular shape, a quadrangular shape, a polygonal shape, etc. The sealing portion 235 is combined with a peripheral portion of the first substrate 210. Each of the discharge channeling portions 231 includes a first region RE1 and a second region RE2. The discharge channeling portions 231 are overlapped with a first external electrode 310 of the external electrode assembly 300 in the first region RE1. The discharge channeling portions 231 are not overlapped with the first external electrode 310 in the second region RE2. That is, the first external electrode 310 resides in the first region RE1, so that light is not generated in the first region RE1. The first external electrode 310 is not in the second region RE2, so that light may be generated in the second region RE2.

The second substrate 230 may further include the connecting passage 237 to connect the adjacent discharge spaces 250. In FIGS. 1 to 3, a connecting passage 237 is formed between adjacent ones of the discharge spaces 250. That is, at least one connecting passage 237 is formed in each of the space dividing portions 233. Alternatively, a plurality of connecting passages may be formed between the adjacent discharge spaces 250. That is, the connecting passages may be formed in each of the space dividing portions. Air may be discharged from the discharge spaces 250 through the connecting passage 237, and a discharge gas may be injected into the discharge spaces 250 through the connecting passage 237. In addition, the discharge gas that is injected into one of the discharge spaces 250 may pass through the connecting passage 237, so that pressure in the discharge spaces 250 is substantially equal. The connecting passage 237 may be formed in various shapes in the molding process used to form the second substrate 230. For example, the connecting passage 237 may have an ‘S’ shape. When the connecting passage 237 has the ‘S’ shape, a path length between the adjacent discharge spaces 250 is increased, so that a current formed by the discharge voltage uniformly flows through the discharge spaces 250.

The external electrode assembly 300 includes the first external electrode 310 and a second external electrode 330. In FIGS. 1 to 3, the first external electrode 310 is on an upper surface of the second substrate 230, and the second external electrode 330 is on a lower surface of the first substrate 210. Each of the first and second external electrodes 310 and 330 is connected across the discharge spaces 250 to apply a discharge voltage to the discharge spaces. For example, a length of each of the first and second external electrodes 310 and 330 is about 10 mm to about 20 mm. In FIGS. 1 to 3, the length of the first external electrode 310 may be about 13 mm, and the length of the second external electrode 330 is about 12 mm. The length of each of the first and second external electrodes 310 and 330 may be changed based on a size of the flat-type fluorescent lamp 100.

The first external electrode 310 may be electrically connected to the second external electrode 330 through a conductive clip (not shown). Alternatively, the first external electrode 310 may be integrally formed with the second external electrode 330 along side portions of a lamp body 200, so that heat generated in the lamp body 200 may be easily radiated.

Each of the first and second external electrodes 310 and 330 includes a conductive material, so that the discharge voltage that is provided from an inverter (not shown) is applied to a lamp body 200 through the first and second external electrodes 310 and 330. Examples of the conductive material that can be used for the first and second external electrodes 310 and 330 are metal, metal alloy, etc. In FIGS. 1 to 3, a silver paste is coated on the lamp body 200 to form the first and second external electrodes 310 and 330. The silver paste that can be used for the first and second external electrodes 310 and 330 includes a mixture of silver and silicon oxide. Alternatively, metal powder may be coated on the lamp body 200 to form the first and second external electrodes 310 and 330. The first and second external electrodes 310 and 330 may be formed through a spray method, a spin coating method, a dipping method, etc. The first and second external electrodes 310 and 330 may be integrally formed with the lamp body 200 by using a metal socket.

The adhesive member 400 is interposed between the first substrate 210 and the sealing portion 235 of the second substrate 230, so the first substrate 210 is combined with the second substrate 230. For example, the adhesive member 400 includes a frit that is a mixture of glass and metal, and a melting point of the frit is lower than pure glass. The adhesive member 400 is on the peripheral portions of the first and second substrates 210 and 230. The adhesive member 400 is prepared between the first and second substrates 210 and 230 and is heated and solidified, so that the second substrate 230 is combined with the first substrate 210. The adhesive member 400 is fired at a temperature of about 400° C. to about 600° C. In FIGS. 1 to 3, the adhesive member 400 includes a protrusion 410 that protrudes from the sealing portion 235 to each of the space dividing portions 233. The protrusion 410 may be extended to a boundary between the first and second regions RE1 and RE2. When the adhesive member does not include the protrusion, a channeling may be formed, adjacent to each of the space dividing portions 233, between the adjacent discharge channeling portions 231, so that plasma is irregularly distributed, thereby deteriorating luminance uniformity. However, in FIGS. 1 to 3, the adhesive member 400 includes the protrusion 410 corresponding to the first region RE1 to decrease the channeling between the adjacent discharge channeling portions 231. For example, a length of the protrusion 410 may be about 17 mm to about 50 mm in a longitudinal direction of the discharge channeling portions 231. In FIGS. 1 to 3, the length of the protrusion 410 is about 20 mm. When the length of the protrusion 410 is less than about 17 mm, the channeling may be formed between the adjacent discharge channeling portions 231. When the length of the protrusion 410 is more than about 50 mm, a portion of the protrusion 410 extends into the second region RE2 and decreases the luminance uniformity.

The space dividing portions 233 of the second substrate 230 are combined with the first substrate 210 by a difference of pressure between the discharge spaces 250 and the exterior of the flat-type fluorescent lamp 100. In particular, the first substrate 210 is combined with the second substrate 230, and air between the first and second substrates 210 and 230 is discharged, so that the discharge spaces 250 are evacuated. The discharge gas is injected into the evacuated discharge spaces 250. The discharge gas includes mercury, neon, argon, etc. In FIGS. 1 to 3, a pressure of the discharge gas in the discharge spaces 250 is about 50 Torr to 70 Torr, and an atmospheric pressure of the outside of the flat fluorescent lamp 100 is about 760 Torr, thereby forming the difference of pressure. Therefore, the space dividing portions 233 of the second substrate 230 are combined with the first substrate 210.

The flat-type fluorescent lamp 200 may further include a first fluorescent layer 271 and a second fluorescent layer 273. The first fluorescent layer 271 is on the first substrate 210 corresponding to the second substrate 230. The second fluorescent layer 273 is on the second substrate 230 corresponding to the first substrate 210. An ultraviolet light that is generated by the plasma discharge is changed into a visible light by the first and second fluorescent layers 271 and 273.

The flat-type fluorescent lamp 200 may further include a reflecting layer 290 interposed between the first substrate 210 and the first fluorescent layer 271. The visible light generated from the first and second fluorescent layers 271 and 272 is reflected from the reflecting layer 290 toward the second substrate 230 to increase the luminance of the backlight assembly 100. The reflecting layer 290 is formed of a highly reflective material. Examples of the highly reflective material that can be used for the reflecting layer 290 are aluminum oxide, barium sulfate, etc.

The reflecting layer 290 and the first fluorescent layer 271 may be formed on the first substrate 210, and the second fluorescent layer 272 may be formed on the second substrate 230 through a spray coating method. In FIGS. 1 to 3, the first fluorescent layer 271 and the reflecting layer 290 are formed on the entire upper surface of the first substrate 210 except a portion of the first substrate 210 corresponding to the adhesive member 400. The second fluorescent layer 272 is formed on the entire lower surface of the second substrate 230 except a portion of the second substrate 230 corresponding to the adhesive member 400. Alternatively, the first and second fluorescent layers 271 and 272 and the reflecting layer 290 may also be formed on the space dividing portions 233.

The flat-type fluorescent lamp 200 may further include a protecting layer (not shown) between the first substrate 210 and the reflecting layer 290 and/or a protecting layer (not shown) between the second substrate 230 and the second fluorescent layer 273. The protecting layer (not shown) prevents a chemical reaction between mercury of the discharge gas and each of the first and second substrates 210 and 230.

In FIGS. 1 to 3, the second substrate 230 is molded to form the discharge spaces 250. Alternatively, the second substrate may have a plate shape that is substantially the same as the first substrate, and a plurality of partition walls may be interposed between the first and second substrates to form the discharge spaces.

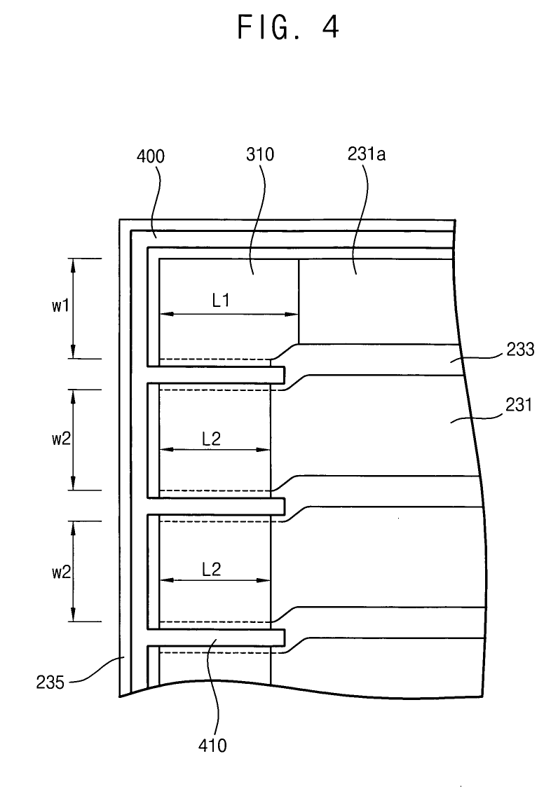

FIG. 4 is a plan view showing a flat-type fluorescent lamp in accordance with an embodiment of the present invention.

Referring to FIG. 4, the discharge channeling portions 231 are spaced apart from each other by a constant distance. The space dividing portions 233 are between the adjacent discharge channeling portions 231 to form the discharge spaces 250. The sealing portion 235 surrounds the peripheral portions of the discharge channeling portions 231 and the space dividing portions 233.

In FIGS. 1 to 4, a width W1 and a length L1 of the first region RE1 corresponding to an outermost discharge channeling portion 231a are different from a width W2 and a length L2 of the first region RE1 corresponding to each of the remaining discharge channeling portions 231. When an amount of a current that flows in each of the discharge spaces 250 is increased, a luminance of the light generated from each of the discharge spaces 250 is increased. The amount of current is changed by a capacitance formed by the first external electrode 310, and the capacitance of each of the discharge channeling portions 231 is changed by changing an area of the first external electrode 310. The outermost discharge channeling portion 231a is adjacent to a receiving container (not shown) that receives the lamp body 200, so that an amount of a leakage current of the outermost discharge channeling portion 231a is increased. Therefore, the width W1 and the length L1 of the first region RE1 corresponding to the outermost discharge channeling portion 231a are increased to compensate for the leakage current, thereby increasing the luminance uniformity. In FIGS. 1 to 4, the length L1 of the outermost discharge channeling portion 231a is greater than the length L2 of each of the remaining discharge channeling portions 231 by about 3 mm.

The lengths of the protrusion 410 of the adhesive member 400 may be greater than the width of the first external electrode 310. That is, the protrusion 410 of the adhesive member 400 may protrude from the first external electrode 310. In order to prevent the channeling between the adjacent space dividing portions 233, the length of the protrusion 410 of the adhesive member 400 may be greater than the length L2 of the first external electrode 310 corresponding to the remaining discharge channeling portions 231.

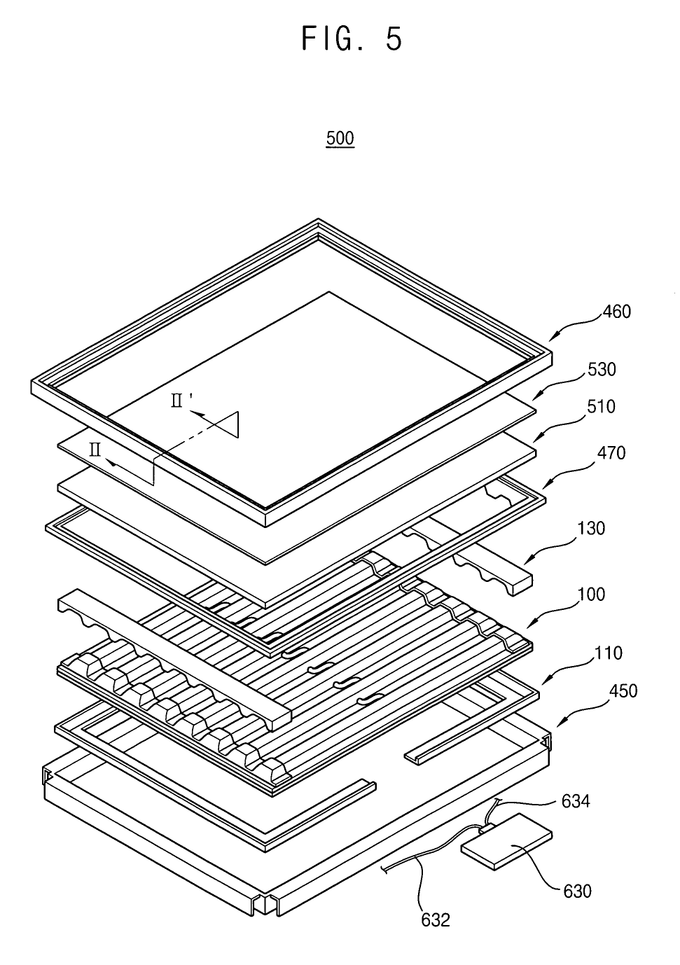

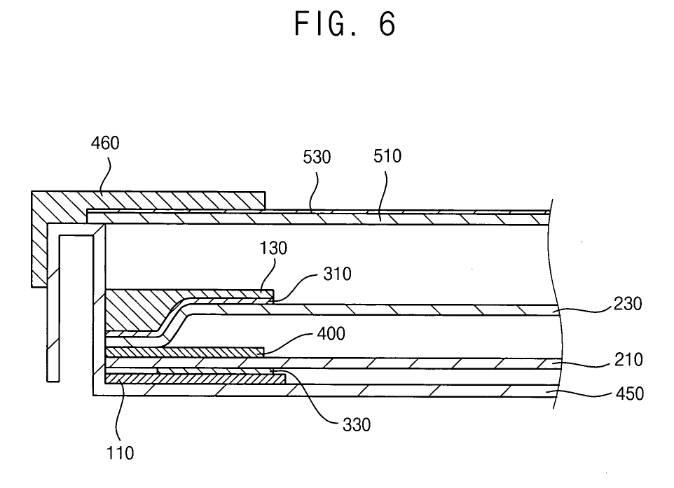

FIG. 5 is an exploded perspective view showing a backlight assembly in accordance with an embodiment of the present invention. FIG. 6 is a cross-sectional view taken along a line 11-II′ shown in FIG. 5.

A flat-type fluorescent lamp of FIGS. 5 and 6 is substantially the same as in FIGS. 1 to 4. Thus, the same reference numerals will be used to refer to the same or like parts as those described in FIGS. 1 to 4 and any further explanation concerning the above elements will be omitted.

Referring to FIGS. 5 and 6, the backlight assembly 500 includes a flat-type fluorescent lamp 100, an insulating member 110, a heat sinking member 130, a bottom chassis 450, an upper mold frame 460, a middle mold frame 470, a diffusion plate 510 and optical sheets 530.

The insulating member 110 corresponds to sides of the flat-type fluorescent lamp 100. The flat-type fluorescent lamp 100 is spaced apart from the bottom chassis 450 by a constant distance using the insulating member 110, so that the flat-type fluorescent lamp 100 is electrically insulated from the bottom chassis 450. The insulating member 110 may include an elastic material. For example, the insulating member 110 may include silicone that is an electrically insulating material and that absorbs an externally provided impact. The insulating member 110 may include two U shaped pieces. Alternatively, the insulating member 110 may include four L shaped pieces corresponding to four corners of the flat-type fluorescent lamp 100. The insulating member 110 may also include four rod shaped pieces corresponding to four sides of the flat-type fluorescent lamp 100. The insulating member 100 may have a frame shape.

The heat sinking member 130 is interposed between a first external electrode 310 of the flat-type fluorescent lamp 100 and sides of the bottom chassis 450. The heat sinking member 130 includes a thermally conductive material to release a heat generated from the first external electrode 310 of the flat-type fluorescent lamp 100 toward the bottom chassis 450. The heat sinking member 130 may make contact with the first external electrode 310, and may have a predetermined viscosity.

The flat-type fluorescent lamp 100, the insulating member 110 and the heat sinking member 130 are received between the bottom chassis 450 and the middle mold frame 470. The bottom chassis 450 includes a bottom plate and a plurality of sidewalls. The bottom plate of the bottom chassis 450 corresponds to the lower surface of the flat fluorescent lamp 100. The sidewalls of the bottom chassis 450 are protruded from sides of the bottom plate. In this exemplary embodiment, each of the sidewalls is bent twice to form a combining space for combining the sidewalls with other elements such as a top chassis, the middle mold frame, etc. That is, each of the sidewalls is first bent in a horizontal direction, and is then subsequently bent in a vertical direction that is substantially perpendicular to the horizontal direction. The bottom chassis 450 is formed of a strong metal to securely receive the flat fluorescent lamp 100. Alternatively, the bottom chassis 450 may include a synthetic resin. The middle mold frame 470 is combined with the bottom chassis 450 and presses a peripheral portion of the flat-type fluorescent lamp 100 to fix the flat-type fluorescent lamp 100. The upper mold frame 460 supports peripheral portions of the diffusion plate 510 and the optical sheets 530. Each of the upper and middle mold frames 460 and 470 may have a frame shape. Alternatively, each of the upper and middle mold frames 460 and 470 may have two pieces or four pieces.

The backlight assembly 500 may further include the diffusion plate 510 and the optical sheets 530. The diffusion plate 510 and the optical sheets 530 are on the flat-type fluorescent lamp 100.

The diffusion plate 510 diffuses a light generated from the flat-type fluorescent lamp 100 to increase a luminance uniformity of the backlight assembly 500. The diffusion plate 510 has a plate shape and has a constant thickness. The diffusion plate 510 is spaced apart from the flat-type fluorescent lamp 100 by a constant distance. For example, the diffusion plate 510 includes polymethylmethacrylate (PMMA) and a diffusing agent. The backlight assembly 500 may further include a supporter (not shown) that is on the flat-type fluorescent lamp 100 to support a central portion of diffusion plate 510, thereby preventing a sagging of the diffusion plate 510. The supporter (not shown) may include a synthetic resin.

The optical sheets 530 increase a luminance of the light having passed through the diffusion plate 510. In particular, the optical sheets 530 may further include a brightness enhancement sheet for enhancing a front-view brightness by adjusting the light-path. The optical sheets 530 may further include a diffusion sheet for enhancing brightness uniformity by diffusing light that has been diffused by the diffusion plate 510. The optical sheets 530 may include various optical sheets for adjusting various characteristics required by the backlight assembly 100.

The backlight assembly 500 may further include an inverter 630 to apply a discharge voltage to the flat-type fluorescent lamp 100.

The inverter 630 may be on an exterior to a receiving container (not shown) receiving the backlight assembly 500. The inverter 630 elevates a level of a voltage that is provided from an exterior to the inverter 630 to generate the discharge voltage for driving the flat-type fluorescent lamp 100. The discharge voltage is applied to the flat-type fluorescent lamp 100 through a first power supply line 632 and a second power supply line 634.

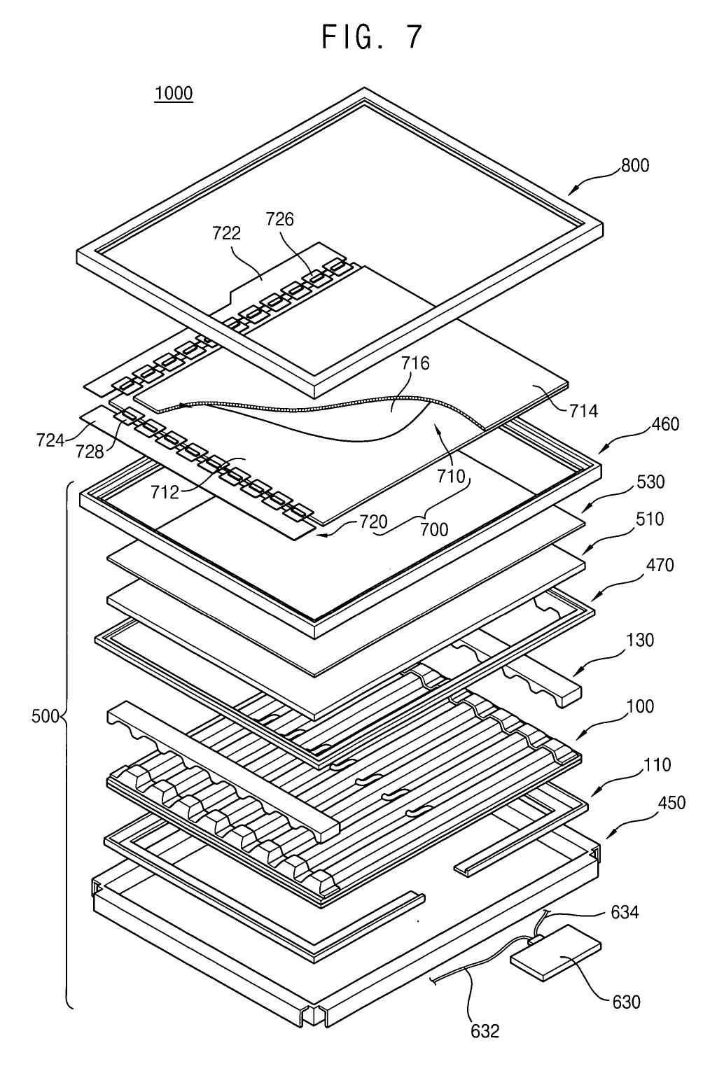

FIG. 7 is an exploded perspective view showing a display device in accordance with an embodiment of the present invention.

Referring to FIG. 7, the display device 1000 includes a backlight assembly 500 and a display unit 700. A flat-type fluorescent lamp 100 and the backlight assembly 500 of FIG. 7 is substantially the same as in FIGS. 1 to 6. Thus, the same reference numerals will be used to refer to the same or like parts as those described in FIGS. 1 to 6 and any further explanation concerning the above elements will be omitted.

The display unit 700 includes a liquid crystal display (LCD) panel 710 and a driving circuit member 720. The LCD panel 710 displays an image using a light generated from the backlight assembly 500. The driving circuit member 720 applies driving signals to the LCD panel 710.

The LCD panel 710 includes a first substrate 712, a second substrate 714 and a liquid crystal layer 716. The second substrate 714 corresponds to the first substrate 712. The liquid crystal layer 716 is interposed between the first and second substrates 712 and 714.

The first substrate 712 includes a plurality of thin film transistors that are arranged in a matrix shape. For example, the first substrate 712 may include a glass substrate. A gate electrode of each of the thin film transistors is electrically connected to one of the gate lines on the glass substrate. A source electrode of each of the thin film transistors is electrically connected to one of the data lines on the glass substrate. A drain electrode of each of the thin film transistors is electrically connected to a pixel electrode that includes a transparent conductive material.

The second substrate 714 may be a color filter substrate that includes red, green and blue color filters. For example, the second substrate 714 may include a glass substrate. The second substrate 714 may further include a common electrode that includes a transparent conductive material.

When gate and data signals are applied to the gate and source electrodes of each of the thin film transistors, respectively, the thin film transistor is turned on to generate an electric field between the pixel electrode and the common electrode. Liquid crystals of the liquid crystal layer 716 vary in arrangement in response to the electric field applied thereto, and thus a light transmittance of the liquid crystal layer 716 is changed to display the image.

The driving circuit member 720 includes a data printed circuit board (PCB) 722, a gate PCB 724, a data driving circuit film 726 and a gate driving circuit film 728. The data PCB 722 applies the data driving signal to the LCD panel 710. The gate PCB 724 applies the gate signal to the LCD panel 710. The data PCB 722 is electrically connected to the LCD panel 710 through the data driving circuit film 726. The gate PCB 724 is electrically connected to the LCD panel 710 through the gate driving circuit film 728. Each of the data and gate driving circuit films 726 and 728 may include a tape carrier package (TCP), a chip on film (COF), etc. Alternatively, an auxiliary signal line is formed on the LCD panel 710 and the gate driving circuit film 728, so that the gate PCB 724 may be omitted.

The display device 1000 may further include a top chassis 800 to fix the display unit 700 to the backlight assembly 500. The top chassis 800 is combined with the bottom chassis 450 to fix the LCD panel 710 to the backlight assembly 500. The data driving circuit film 726 is bent toward a rear surface of the bottom chassis 400 along a side surface of the bottom chassis 400, so that the data PCB 722 is on the rear surface of the bottom chassis 400. The top chassis 800 may be formed of a strong metal.

According to embodiments of the present invention, the channeling is decreased in the initial stage of generating light in order to increase a luminance uniformity of the backlight assembly, thereby improving an image display quality of the display device.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A flat-type fluorescent lamp comprising:
a first substrate;
a second substrate corresponding to the first substrate to form a plurality of discharge spaces; and
an adhesive member interposed between the first and second substrates to combine the first substrate to the second substrate, the adhesive member including a protrusion, protruding in a longitudinal direction of the discharge spaces.

2. The flat-type fluorescent lamp of claim 1, further comprising an external electrode assembly adjacent to a side of the first substrate or the second substrate.

3. The flat-type fluorescent lamp of claim 2, wherein the external electrode assembly comprises:
a first external electrode on an upper surface of the second substrate; and
a second external electrode on a lower surface of the first substrate.

4. The flat-type fluorescent lamp of claim 3, wherein the first external electrode is electrically connected to the second external electrode along side surfaces of the first and second substrates.

5. The flat-type fluorescent lamp of claim 4, wherein the first external electrode is electrically connected to the second external electrode through a conductive clip.

6. The flat-type fluorescent lamp of claim 1, further comprising:
a first fluorescent layer on an upper surface of the first substrate corresponding to the second substrate; and
a reflecting layer interposed between the first fluorescent layer and the upper surface of the first substrate.

7. The flat-type fluorescent lamp of claim 1, wherein the second substrate comprises:
a plurality of discharge channeling portions spaced apart from the first substrate to form the plurality of discharge spaces;
a plurality of space dividing portions making contact with the first substrate between the discharge channeling portions; and
a sealing portion on a peripheral portion of the second substrate, the sealing portion being connected to the first substrate through the adhesive member.

8. The flat-type fluorescent lamp of claim 7, wherein the second substrate further comprises a second fluorescent layer on a lower surface of the second substrate.

9. The flat-type fluorescent lamp of claim 7, wherein each of the plurality of space dividing portions comprises at least one connecting passage to connect adjacent ones of the plurality of adjacent discharge spaces.

10. The flat-type fluorescent lamp of claim 1, wherein the protrusion is integrally formed with the adhesive member between the discharge spaces.

11. The flat-type fluorescent lamp of claim 10, wherein a length of the protrusion is about 17 mm to about 50 mm in a longitudinal direction of each of the discharge spaces.

12. The flat-type fluorescent lamp of claim 11, wherein the length of the protrusion is about 20 mm in the longitudinal direction of each of the discharge spaces.

13. A backlight assembly comprising:
a flat-type fluorescent lamp including:
a lamp body generating light, the lamp body including an adhesive member having a protrusion protruding toward a central portion of the lamp body;
a first external electrode on an upper surface of the lamp body; and
a second external electrode on a lower surface of the lamp body;
a receiving container including a bottom plate and a sidewall to receive the flat-type fluorescent lamp; and
an insulating member interposed between the flat-type fluorescent lamp and the receiving container, so that the flat-type fluorescent lamp is spaced apart from the receiving container.

14. The backlight assembly of claim 13, further comprising:
a diffusion plate on the flat-type fluorescent lamp to diffuse the light generated from the flat-type fluorescent lamp.

15. The backlight assembly of claim 13, further comprising an inverter for driving the flat-type fluorescent lamp.

16. The backlight assembly of claim 13, wherein the flat-type fluorescent lamp further comprises:
a first substrate including:
a first fluorescent layer on an upper surface of the first substrate; and
a reflecting layer interposed between the first fluorescent layer and the upper surface of the first substrate; and
a second substrate corresponding to the first substrate to form a plurality of discharge spaces.

17. The backlight assembly of claim 16, wherein the second substrate comprises a second fluorescent layer on a lower surface of the second substrate corresponding to the first substrate.

18. The backlight assembly of claim 16, wherein the second substrate comprises:
a plurality of discharge channeling portions spaced apart from the first substrate to form the plurality of discharge spaces;
a plurality of space dividing portions making contact with the first substrate between the plurality of discharge channeling portions; and
a sealing portion on a peripheral portion of the second substrate, the sealing portion being connected to the first substrate through the adhesive member.

19. The backlight assembly of claim 18, wherein each of the plurality of space dividing portions comprises at least one connecting passage to connect adjacent ones of the plurality of discharge spaces.

20. The backlight assembly of claim 13, wherein the protrusion is integrally formed with the adhesive member between the discharge spaces.

21. The backlight assembly of claim 20, wherein a length of the protrusion is about 17 mm to about 50 mm in a longitudinal direction of each of the discharge spaces.

22. The backlight assembly of claim 21, wherein the length of the protrusion is about 20 mm in the longitudinal direction of each of the discharge spaces.

23. A flat-type fluorescent lamp comprising:
a first substrate; and
a second substrate including:
a plurality of discharge channeling portions spaced apart from the first substrate;
a plurality of space dividing portions making contact with the first substrate between the discharge channeling portions, end portions of each of the space dividing portions being attached to the first substrate, a remaining portion of each of the space dividing portions making contact with the first substrate; and
a sealing portion on a peripheral portion of the second substrate, the sealing portion being attached to the first substrate.

24. The flat-type fluorescent lamp of claim 23, wherein the second substrate is attached to the first substrate through an adhesive member, and the adhesive member is on the sealing portion and the end portions of each of the space dividing portions.

25. The flat-type fluorescent lamp of claim 23, wherein the adhesive member comprises a frit.

26. The flat-type fluorescent lamp of claim 23, further comprising an external electrode on a surface of the first substrate or the second substrate so as to cover at least part of the end portions of each of the space dividing portions.

27. A method of manufacturing a flat-type fluorescent lamp comprising:
forming a first substrate;
forming a second substrate including a plurality of discharge channeling portions, a plurality of space dividing portions between the discharge channeling portions and a sealing portion on a peripheral portion of the second substrate; and
attaching the sealing portion and end portions of each of the space dividing portions to the first substrate.

28. The method of claim 27, wherein the sealing portion and the end portions of each of the space dividing portions are attached to the first substrate through a frit.

29. The method of claim 28, further comprising forming an external electrode on an upper surface of the second substrate to cover at least part of the end portions of each of the space dividing portions.
